(19) United States
(12) Patent Application Publication
(10) Pub. No.: US 2012/0168684 A1
(43) Pub. Date: Jul. 5, 2012

(54) PROCESS FOR SINTERING NANOPARTICLES AT LOW TEMPERATURES

(75) Inventors: Shlomo Magdassi, Jerusalem (IL); Michael Grouchko, Jerusalem (IL); Alexander Kamyshny, Jerusalem (IL)

(73) Assignee: Yissum Research Development Company of the Hebrew University of Jerusaem, Ltd., Jerusalem (IL)

(21) Appl. No.: 13/258,766

(22) PCT Filed: Mar. 24, 2010
(86) PCT No.: PCT/IL10/00249

§ 371 Date: Jan. 17, 2012

Related U.S. Application Data
(60) Provisional application No. 61/162,744, filed on Mar. 24, 2009.

(51) Int. Cl. B05D 5/12; B05D 3/02; B05D 5/00; H01B 1/00; B05D 7/24; B05D 3/00; B82Y 40/00; B82Y 30/00

(52) U.S. Cl. 252/500; 427/189; 427/372.2; 427/190; 427/191; 427/192; 427/256; 427/58; 977/773; 977/840; 977/810

(57) ABSTRACT

Provided is a process for low temperature sintering of a pattern on a substrate.

### FIELD OF THE INVENTION

This invention generally relates to a process for sintering nanoparticles by employing low temperature sintering process to obtain a continuous network.

### BACKGROUND OF THE INVENTION

Fabrication of electric circuits on polymeric substrates, known as “plastic electronics”, and on other sensitive substrates like paper and packages has attracted significant interest as a pathway to flexible, transparent, and low-cost devices [1,2]. Inkjet technology can be utilized for direct printing of conductive patterns [3,4], overcoming disadvantages of other printing methods, such as lithography [5] and screen printing [3]. However, one of the major challenges in flexible and plastic electronics is obtaining conductive patterns at sufficiently low temperatures, which do not damage the polymeric substrate or paper.

The inks used for the fabrication of conductive patterns by inkjet printing usually contain metallic nanoparticles (NPs) and organic stabilizers (surfactants and polymers) dispersed in water or a solvent [4,6,7]. After printing and drying, a pattern composed of conducting metallic NPs capped with insulating organic stabilizers is formed. Due to the presence of insulating organic materials within the NP array, the number of percolation paths is limited and the resistivity of the printed pattern is too high. This obstacle is conventionally overcome by a post-printing sintering process, achieved by heating the printed substrate to a temperature typically higher than 150° C., in an oven [8-11], by applying microwave [12] or photonic radiation [13,14,15] or by applying electrical voltage [16]. This sintering phenomenon is usually attributed to the reduced melting point of NPs and to their surface pre-melting [17-19].

However, due to the sensitivity of paper and plastic substrates to elevated temperatures, such treatments are usually not suitable for these substrates and therefore fabrication of flexible devices for plastic electronics is limited to a small number of heat resistant polymers such as polyimide. Obviously, there is a great need in a technology that enables sintering of metallic NPs without heating the substrate.

The ability to decrease the resistivity of printed silver NPs was recently demonstrated by Zapka et al. [20,21]. The decrease in the resistivity was achieved by stamping the printed silver pattern with 0.01 to 0.27M NaCl solutions, followed by heating to 95° C. Low resistivities were obtained only at the highest NaCl concentration, which was a saturated solution.

Another process for sintering of NPs was reported by Wakuda et al., [22,23] in which the printed pattern was dipped into a solvent, which apparently led to desorption of the particle stabilizer, dodecylamine. Very high resistivities were obtained.

### REFERENCES

[1] S. R. Forrest, Nature 2004, 428, 911.
[2] G. Eda, G. Fanchini, M. Chhowalla, Nature Nanotechnology 2008, 3, 270.
[3] F. Garnier, R. Hajlaoui, A. Yassar, P. Srivastava, Science 1994, 265, 1684.
[4] S. Sivaramakrishnan, P. J. Chia, Y. C. Yeo, L. L. Chua, P. K. H. Ho, Nature Materials 2007, 6, 149.
[5] I. Park, S. H. Ko, H. Pan, C. P. Grigoropoulos, A. P. Pisano, J. M. J. Frechet, E. S. Lee, J. H. Jeong, Advanced Materials 2008, 20, 489.
[6] T. H. J. van Osch, J. Perelaer, A. W. M. de Laat, U.S. Schubert, Advanced Materials 2008, 20, 343.
[7] D. Kim, S. Jeong, B. K. Park, J. Moon, Applied Physics Letters 2006, 89.
[8] S. B. Fuller, E. J. Wilhelm, J. A. Jacobson, Journal of Microelectromechanical Systems 2002, 11, 54.
[9] S. Joo, D. F. Baldwin, Electronic Components and Technology Conference 2007, 212.
[10] J. B. Szczech, C. M. Megaridis, J. Zhang, D. R. Gamota, Microscale Thermophysical Engineering 2004, 8, 327.
[11] D. Kim, J. Moon, Electrochemical and Solid State Letters 2005, 8, J30.
[12] J. Perelaer, B. J. de Gans, U.S. Schubert, Advanced Materials 2006, 18, 2101.
[13] S. H. Ko, H. Pan, C. P. Grigoropoulos, C. K. Luscombe, J. M. J. Frechet, D. Poulikakos, Applied Physics Letters 2007, 90.
[14] N. R. Bieri, J. Chung, D. Poulikakos, C. P. Grigoropoulos, Superlattices and Microstructures 2004, 35, 437.
[15] H-S. Kim, S. R. Dhage, D-E. Shim, H. T. Hahn, Appl. Phys. A 2009, 97, 791.
[16] M. L. Allen, M. Aronniemi, T. Mattila, A. Alastalo, K. Ojanpera, M. Suhonen, H. Seppä, Nanotechnol. 2008, 19, 175201.
[17] J. W. M. Frenken, J. F. Vanderveen, Physical Review Letters 1985, 54, 134.
[18] L. J. Lewis, P. Jensen, J. L. Barrat, Physical Review B 1997, 56, 2248.
[19] K. S. Moon, H. Dong, R. Maric, S. Pothukuchi, A. Hunt, Y. Li, C. P. Wong, Journal of Electronic Materials 2005, 34, 168.
[20] W. Zapka, W. Voit, C. Loderer, P. Lang, Digital Fabrication 2008 2008, 906-911.
[21] T. F. Tadros, Colloid Stability. Wiley-VCH: Weinheim, 2007.
[22] D. Wakuda, K. Kim, K. Suganuma, Scripta materialia 2008, 59, 649-652.
[23] D. Wakuda, M. Hatamura, K. Suganuma, Cemical Physics Letters 2007, 441, 305-308.
[24] Magdassi, S., Kamyshny, A., Aviezer, S., Grouchko, M., WO2006072959.
[25] P. A. Buffat, Materials Chemistry and Physics 2003, 81, 368.
[26] G. Palasantzas, T. Vystavel, S. A. Koch, J. T. M. De Hosson, Journal of Applied Physics 2006, 99.
[27] M. Jose-Yacaman, C. Gutierrez-Wing, M. Miki, D. Q. Yang, K. N. Piyakis, E. Sacher, Journal of Physical Chemistry B 2005, 109, 9703.
[28] T. Hawa, M. R. Zachariah, Journal of Aerosol Science 2006, 37, 1.
[29] Y. Chen, R. E. Palmer, J. P. Wilcoxon, Langmuir 2006, 22, 2851.
[30] P. A. Buffat, Philosophical Transactions of the Royal Society of London Series a-Mathematical Physical and Engineering Sciences 2003, 361, 291.
[31] Hanmura, M. et al., JP20010009486.
[32] M. Yoshida, A. Mikami, T. Inoguchi, N. Miura, Phosphor Handbook, CRC Press, 2006.

### SUMMARY OF THE INVENTION

In the present application a new technology is disclosed for achieving sintering of nanoparticles (NPs) at a low temperature by a sintering agent, which leads to aggregation and coalescence of the NPs on a substrate. This results in a continuous network of sintered NPs, which in the case of metallic NPs possesses high electrical conductivity. The applicability of the process of the invention in achieving a continuous network of sintered NPs having high electrical conductivity, at room temperature, on a substrate such as poly(ethylene terephthalate) (PET) is demonsarted.

Thus, in one aspect of the invention there is provided a process for sintering nanoparticles (NPs) on a substrate, the process comprising contacting said nanoparticles with a sintering agent at a low temperature (at a temperature which is lower than the typical sintering temperature), thereby obtaining a sintered pattern on said substrate.

In some embodiments, the contacting of the NPs with the sintering agent on the substrate is achieved in a two-step process, involving an initial pre-treatment (pre-coating) of the substrate by the sintering agent or by the NPs. In embodiments where the substrate is pre-treated (pre-coated) with the sintering agent, subsequent thereto NPs are deposited onto the pre-treated substrate and the NPs are allowed to undergo sintering. In embodiments where the substrate is pre-treated with NPs (pre-coated to obtain a film thereof), subsequent to NP film formation, the film is treated with a sintering agent and allowed to undergo sintering.

In other embodiments, the low temperature sintering is achieved by depositing a formulation (dispersion), herein referred to as an “ink formulation”, comprising both the NPs and the sintering agent. Thus, prior to printing or depositing or contacting the substrate with the NPs and the at least one sintering agent, they are pre-formulated in an aqueous medium. Subsequent to deposition thereof onto the substrate, the solvent (typically water) evaporates, leading to an increase in the relative concentration of the sintering agent, thereby triggering sintering of the NPs.

An “aqueous ink formulation” according to the invention refers to an ink formulation, as defined, wherein the carrier or medium is water or containing water; the water may be of a variety of purities, e.g., distilled, deionized, etc. Typically, the formulation comprises water in an amount between 50 and 90% w/w of the formulation.

In some embodiments, the formulation (dispersion) comprises a low concentration of the sintering agent, namely a concentration which is below the critical coagulation concentration (CCC), so that the obtained dispersion containing the sintering agent remains stable for prolonged periods of time. The critical coagulation concentration is an indicator relating to the stability of the sintering agent in the aqueous dispersion and is the concentration of the sintering agent causing coagulation when added to the dispersion formulation. The critical coagulation concentration can be known by the description in, for example, S. Okamura et al. “Koubunshi Kagaky (Polymer Chemistry)”, 17, 601, 1960.

Alternatively, the zeta-potential of the dispersion may be measured while adding a measured amount of the sintering agent to the dispersion so as to vary the concentration thereof in the dispersion and the coagulation concentration is determined by the point where the variation of zeta-potential is observed. The zeta-potential of the NPs dispersed in the ink formulation of the invention, prior to application, is higher than |±15| mV. Upon evaporation (fully or partially) of the aqueous medium, the zeta-potential of the NPs decreases to less than |±15| mV.

Thus, in another aspect of the invention, there is provided a process for forming a self-sintered pattern on a substrate, the process comprising inkjet printing onto said substrate an aqueous ink formulation of nanoparticles. (NPs) and at least one sintering agent and permitting said pattern to dry, thereby forming a sintered pattern on said substrate.

In some embodiments, the sintering of the nanoparticles upon drying of the printed pattern is carried out at a low temperature which is typically between 5 and 150° C. In some embodiments, the temperature is between 5 and 100° C. In further embodiments, the temperature is between 5 and 50° C. or between 5 and 30° C.

In some embodiments, the sintering temperature does not exceed 50° C. In other embodiments, the sintering temperature is at or around room temperature, namely between 20 and 30° C.

In further embodiments, the sintering is spontaneous and does not require external application of energy, e.g., heat.

As disclosed, the pattern obtained according to the process of the invention is “self-sintered”, namely it undergoes spontaneous sintering once the aqueous medium partially or fully dries. The formation of the pattern with the ink formulation, on the substrate, does not necessitate any pre- or post treatment of the substrate by either component of the ink formulation, as defined.

The aqueous ink formulation of the invention, employed in the process, typically comprises a plurality of nanoparticles, at least one sintering agent and at least one dispersant. The plurality of nanoparticles may or may not be of the same material, same shape and/or size, or same chemical and/or physical properties.

The nanoparticles are typically nanometer in size (between 1 and 1000 nm), namely each of the nanoparticles is characterized by having at least one feature which is nanometric (between 1 and 1000 nm). In some embodiments, the nanoparticles are rod-like particles having a nanometric or micrometric (above 1000 nm) length and a nanometric diameter. In other embodiments, the nanoparticles are rod-like particles of micrometric length, having on their surface at least one feature (e.g., protrusion) of a nanometric size.

In further embodiments, the nanoparticles are sphere-like particles or substantially spherical particles of a nanometric diameter.

In some embodiments, the formulation or any one process of the invention employs a mixture of nanoparticle types, each type varies from the other in size and/or shape. The mixture of nanoparticles typically comprises at least 5% nanoparticles having at least one dimension smaller than 100 nm in diameter. In other embodiments, the mixture comprises at least 10% nanoparticles having at least one dimension smaller than 100 nm in diameter. In still other embodiments, the mixture comprises at least 50% nanoparticles having at least one dimension smaller than 100 nm in diameter.

The formulation may further comprise, in addition to the NPs, the sintering agent and the dispersant, at least one additive selected to enhance performance, environmental effect, aesthetic effect, or any other property of the ink formulation. For some inkjet applications, the formulation may also comprise at least one additive which permits smooth, continuous and uninterrupted inkjetting. The at least one additive may be selected and incorporated into the formulation based on any one property or characteristic of the formulation and/or its final use or application. Non-limiting examples of such additives are buffers, pH adjusting agents, biocides, sequestering agents, chelating agents, corrosion inhibitors, stabilizing agents, humectants, co-solvents, fixatives, penetrants, surfactants, colorants, magnetic materials and others.

The NPs are typically metallic nanoparticles or nanoparticles made of a metal oxide or a semiconductor material. In some embodiments, the NPs are made from a material selected from silver, copper, gold, indium, tin, iron, cobalt, platinum, titanium, titanium oxide, silicon, silicon oxide or any oxide or alloy thereof. The nanoparticles are typically smaller than 100 nm in diameter. The NPs constitute between about 1 and 80% w/w of the total weight of the formulation.

The sintering agent is a coagulant material, capable of coagulating the NPs under the specified conditions. The sintering agent is selected to cause at least one of: (i) irreversible coalescence of the closely located NPs due to neutralization of the charges at the NPs surface, (ii) screening charges at the NPs surface, (iii) desorption of the dispersing agent, or (iv) any other mechanism which enables coagulation and coalescence. The sintering agents are thus selected amongst salts, e.g., agents containing chlorides such as KCl, NaCl, MgCl₂, AlCl₃, LiCl, CaCl₂; charged polymers, polycations, e.g., poly(diallyldimethylammonium chloride) (PDAC); polyimides, polypyrroles; polyanions; polyacrylic acid (PAA), polyethyleneimine, carboxymethyl cellulose (CMC), polynaphthalene sulfonate/formaldehyde poly(γ-glutamic acid); acids, e.g., HCl, H₂SO₄, HNO₃, H₃PO₄, acetic acid, acrylic acid; and bases, e.g., ammonia, organic amines, e.g. aminomethyl propanol (AMP), NaOH and KOH. The sintering agent molar concentration is between about 0.1 to 500 mM of the formulation.

As stated above, the formulation may also comprise at least one dispersant capable of promoting the formation and stabilization of the formulation of the invention, prior to application. The at least one dispersant is selected amongst polyelectrolites or polymeric materials capable of forming salts with a multitude of electrolytes. Representative examples of such dispersants include without limitation polycarboxylic acid esters, unsaturated polyamides, polycarboxylic acids, alkyl amine salts of polycarboxylic acids, polyacrylate dispersants, polyethyleneimine dispersants, and polyurethane dispersants.

In some embodiments, the dispersant is selected without limitation from: Disperse BYK® 190, Disperse BYK® 161, Disperse BYK® 163, Disperse BYK® 164, Disperse BYK® 2000 and Disperse BYK® 2001, all of which available from BYK; EFKA® 4046 and EFKA® 4047, available from EFKA; and Solsperse® 40000 and Solsperse® 24000 available from Lubrizol; and XP 1742 available from Coatex.

In further embodiments, the dispersant is a surfactant, which may or may not be ionic. In some embodiments, the surfactant is cationic or anionic. In further embodiments, said surfactant is non-ionic or zwitterionic. Non-limiting examples of such cationic surfactants such as didodecyldimethylammonium bromide (DDAB), CTAB, CTAC cetyl(hydroxyethyl)(dimethyl)ammonium bromide, N,N-dimethyl-N-cetyl-N-(2-hydroxyethyl)ammonium chloride, anionic surfactants such as sodium dodecyl sulfate (SDS) and various unsaturated long-chain carboxylates, zwitterionic phospholipids, such as 1,2-bis(10,12-tricosadiynoyl)-sn-glycero-3-phosphochline, water-soluble phosphine surfactants, such as sodium salts of sulfonated triphenylphosphine, P(m-C₆H₄SO₃Na)₃ and alkyltriphenyl-methyltrisulfonate, RC (p-C₆H₄SO₃Na)₃, alkyl polyglycol ethers, e.g., ethoxylation products of lauryl, tridecyl, oleyl, and stearyl alcohols; alkyl phenol polyglycol ethers, e.g., ethoxylation products of octyl- or nonylphenol, diisopropyl phenol, triisopropyl phenol; alkali metal or ammonium salts of alkyl, aryl or alkylaryl sulfonates, sulfates, phosphates, and the like, including sodium lauryl sulfate, sodium octylphenol glycolether sulfate, sodium dodecylbenzene sulfonate, sodium lauryldiglycol sulfate, and ammonium tri-tert-butyl phenol and penta- and octa-glycol sulfonates; sulfosuccinate salts, e.g., disodium ethoxylated nonylphenol ester of sulfosuccinic acid, disodium n-octyldecyl sulfosuccinate, sodium dioctyl sulfosuccinate, and the like.

According to some embodiments of the invention, the ink formulation or any component thereof, in accordance with any process of the invention as disclosed throughout, is applied onto a substrate by inkjet printing. As used herein, the term “inkjet printing” refers to a non-impact (non-stamping) method for producing the pattern by the deposition of ink droplets in a pixel-by-pixel manner onto the substrate. The inkjet technology which may be employed in a process of the invention for depositing ink or any component thereof onto a substrate, according to any aspect of the invention, may be any inkjet technology known in the art, including thermal inkjet printing, piezoelectric inkjet printing and continuous inkjet printing.

To permit unarrested and efficient inkjet printing of the ink formulation of the invention, in some embodiments, the viscosity of the formulation ranges from 1 cps to 60 cps at 20?C. In further embodiments, the viscosity is between 1 cps and 20 cps at 20?C. In other embodiments, the viscosity is between 3 cps and 15 cps at 20?C or between 4 cps and 12 cps at 20?C.

The pattern of sintered NPs is formed on a substrate by any available means and depending on the film size, complexity of structure (regular 3D structure, irregular structure, etc), the substrate and the NPs employed. In some embodiments, the pattern is formed by contacting the substrate with a solution comprising said NPs, said contacting being selected from coating, dipping, printing, ink-jetting, and by any other means.

In some embodiments, the pattern covers the full surface of a substrate. In other embodiments, the pattern is a continuous pattern on said substrate or a plurality of spaced apart patterns on said substrate.

In some embodiments, the thickness of the pattern is between 0.05 to 50 micrometers.

The substrate, on top of which a sintered pattern is formed, may be any substrate which is stable or degradable (may be damaged) under the high sintering temperatures typically employed in sintering processes, but which is stable and remains undamaged under the sintering conditions of the present invention. The substrate may be of a single material, e.g., a metal, and may have a surface material which is the same or different from the substrate material itself. The substrate and/or its surface, independently of each other, may be selected from glass, polymeric films, plain paper, porous paper, non-porous paper, coated paper, flexible paper, copier paper, photo paper, glossy photopaper, semi-glossy photopaper, heavy weight matte paper, billboard paper, vinyl paper, high gloss polymeric films, transparent conductive materials, and plastic (poly(ethylene terephthalate), PET, polyacrylates (PA), polyethilene naphtalate (PEN), polyethersulphone (PES), polyethylene (PE), polyimide (PI), polypropylene (PP), polycarbonate (PC) and others. The substrate may be a porous substrate or a smooth substrate.

In some embodiments, the pattern formed prior to sintering is non-conductive. In other embodiments, the sintered pattern is conductive, e.g., having electrical conductivity greater than 1% bulk silver. In some embodiments, the electrical resistivity of the conductive pattern is lower than 1.6·10⁻⁶ Ωm.

In some embodiments, the substrate is covered with at least two disconnected patterns, which may or may not each be conductive. In some embodiments, the nanoparticle film is sintered at spaced apart regions thereby affording a pattern having regions of conductivity and regions of non-conductivity.

In some cases, the substrate is fully covered with a conductive pattern (or film), wherein conductivity may be measured at any two points along the substrate.

In another aspect of the invention, a process is provided for forming an electrically conductive pattern on a substrate, said process comprising contacting a film of metallic nanoparticles on said substrate with at least one sintering agent at room temperature, thereby obtaining an electrically conductive pattern.

Additionally, a process is provided for forming an electrically conductive pattern on a substrate, said process comprising contacting a film of at least one sintering agent on a substrate, at room temperature, with metallic nanoparticles, thereby obtaining an electrically conductive pattern

In a further aspect of the invention, there is provided a process for forming an electrically conductive pattern on a substrate, said process comprising forming a film of metallic nanoparticles on said substrate, treating said film with at least one sintering agent at room temperature, i.e., at a temperature between 23 and 27° C., whereby nanoparticles treated with said agent are sintered to afford a conductive pattern.

In another aspect of the invention, there is provided a process for forming a conductive pattern on a substrate, which may or may not be conductive prior to sintering, said process comprising forming a pattern on said substrate with a composition comprising metallic nanoparticles, at least one sintering agent and a liquid carrier, permitting evaporation of said liquid carrier at a low temperature, thereby leading to a sintered conductive pattern.

The invention also provides a process for printing a self-sintering pattern on a substrate, said process comprising applying onto a substrate an ink formulation according to the invention and permitting said pattern undergo sintering, as disclosed herein.

In another aspect of the invention, there is provided an article having at least one substrate, e.g., conductive, prepared according to a process of the invention.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 provides an illustration of the sintering process of the invention.

FIG. 2 is a SEM image of a printed drop zone (center) and the magnified images of NPs array after the contact with PDAC outside (left) and inside (right) the droplet zone.

FIGS. 3A-B present the (FIG. 3A) Zeta-potential of silver NPs aqueous dispersions and a schematic illustration of the NPs state at various PDAC concentrations and (FIG. 3B) the particles size at various zeta potential values.

FIGS. 4A-C are SEM images of negatively charged silver NPs printed on (FIG. 4A) glass, (FIG. 4B) glass pre-coated with PDAC, and (FIG. 4C) PET pre-coated with PDAC (the same scale bar for all images).

FIGS. 5A-C are (FIG. 5A) macroscopic image of a pattern printed on Epson photo paper and SEM images of (FIG. 5B) the surface and (FIG. 5C) the cross-section of the same pattern.

FIGS. 6A-B are illustrative of a process according to the invention: FIG. 6A is a schematic illustration of the EL device and the printing process, and FIG. 6B is an illustration of an electroluminescence working device.

### DETAILED DESCRIPTION OF EMBODIMENTS

### Room Temperature Sintering—Mechanism

### Example 1

### Sintering by PDAC on Preformed Silver NPs Pattern

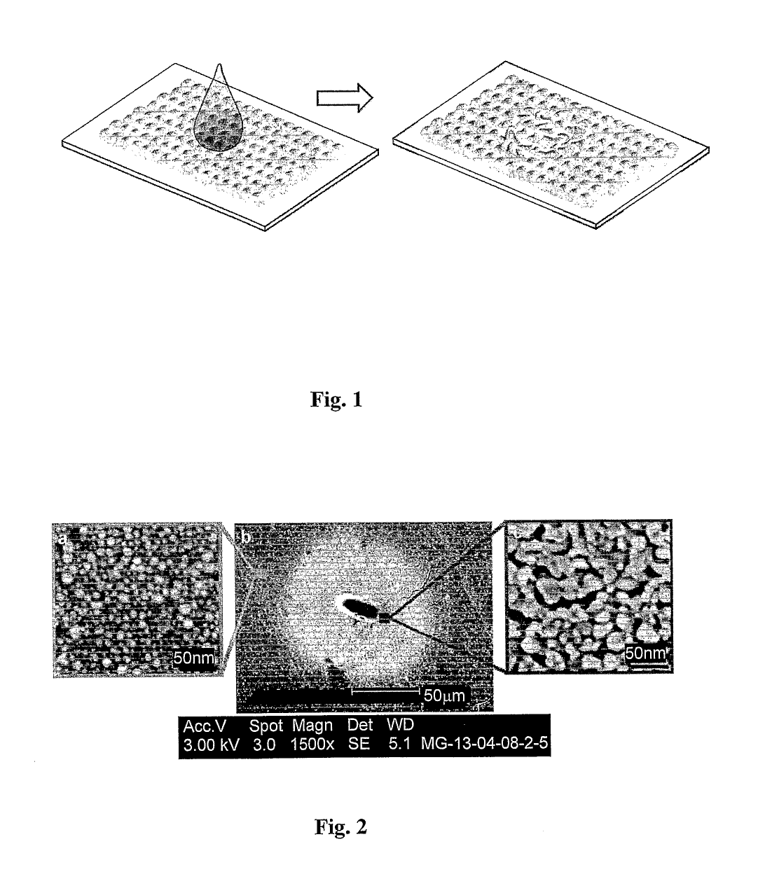

A general illustration of the sintering process according to the invention is provided in FIG. 1.

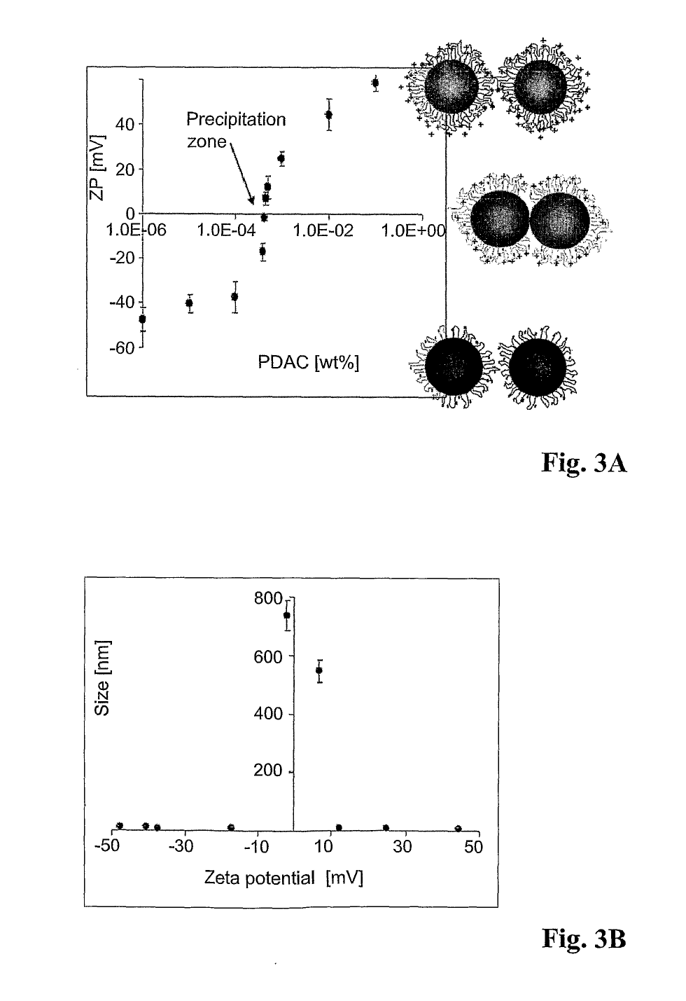

An aqueous ink composed of silver NPs with a diameter of 5 to 20 nm, stabilized by polyacrylic acid, as described previously [24], was ink-jet printed on a glass slide. As expected, after drying at room temperature, the printed pattern composed of closely packed individual silver NPs (FIG. 2 left expansion) and possessed a resistivity greater than the Ohmmeter threshold, i.e. more than a million times the bulk silver resistivity.

At the next step, a solution of a polycation, poly(diallyldimethylammonium chloride) (PDAC), was printed on top of the silver pattern as an individual droplet (FIG. 2 center). Surprisingly, it was found that within the zone of the polycation printed droplet, spontaneous sintering of the silver NPs occurred at room temperature (although the melting point of silver is 961° C.), as demonstrated in the right-hand expansion in FIG. 2. The difference between the sintered NPs, within the droplet zone of PDAC, and the well-confined NPs outside this zone, was evident. Without being bound by theory, it is believed that this coalescence led to a significant conductivity of the printed pattern.

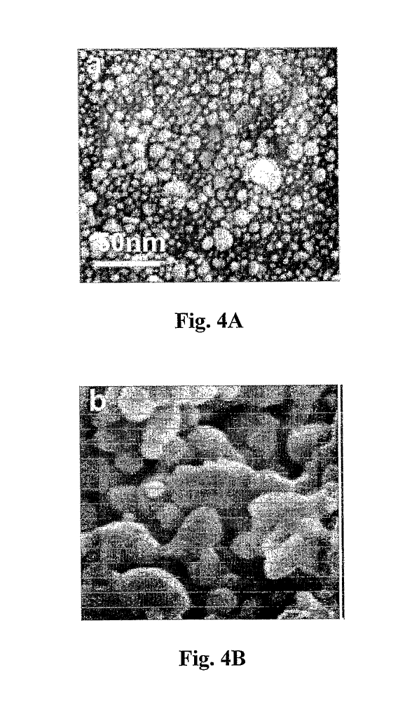

In order to understand the role of PDAC in this room temperature sintering process, the effect on an aqueous dispersion of the same NPs was evaluated. The zeta (ζ) potential and average particles size of such dispersions as a function of PDAC concentration is presented in FIGS. 3A-B.

As may be understood from FIG. 3A, the ζ-potential of the original NPs was −47±3 mV, and its negative value decreased with the increase in PDAC concentration. At a concentration as low as 4.2 10⁻⁴ wt % PDAC, the ζ-potential reached a zero value, and rapid precipitation was observed due to aggregation of the nanoparticles evidently due to a drastic increase in the average in particles size (FIG. 3B). Further increase in the PDAC concentration led to re-stabilization of the silver NPs, which displayed a positive ζ-potential (charge inversion).

As it follows from FIGS. 3A-B, at concentrations around the point of zero charge, PDAC behaved as a coagulant for the metallic NPs by charge neutralization. Interestingly, this charge neutralization process, while performed in a closely packed array of nanoparticles on a solid substrate, led to their irreversible coalescence, which was actually a sintering process taking place at room temperature. A coalescence process of individual NPs (not arrays), taking place when two NPs were allowed to come close enough, was previously reported during an in situ characterization of metallic NPs by high resolution transmission electron microscopy [16,25-30].

### Example 2

### Sintering by Printing Ag NPs on Preformed PDAC Layer

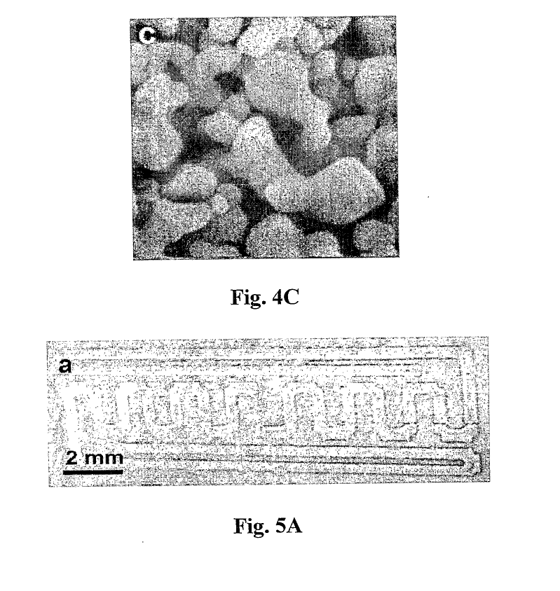

The room temperature sintering process was also observed while drops of the silver NPs dispersion were printed on top of a substrate that was pre-coated with PDAC. The printing was conducted on glass and PET substrates, which were pre-coated with a PDAC solution (by spreading). It was found that the resulting printed patterns were composed of sintered NPs, as clearly seen in the SEM image (FIGS. 4B and 4C). For comparison, printing on a glass substrate without the PDAC pre-coating resulted in patterns composed of non-sintered individual nanoparticles (FIG. 4A).

Similarly to the coagulation effect of polycation molecules on silver NPs dispersed in water, when a polycation was used as a “sintering agent” (printed on a preprinted silver pattern or deposited on a substrate before the silver NPs deposition), the coalescence mechanism resulted from the diffusion of free polycaion chains between the silver NPs causing a charge neutralization and resulting in a dried sintered pattern.

### Example 3

### Conductivity and Formation of an Electroluminescence Device

The applicability of the room temperature sintering process of the invention in the formation of conductive patterns on flexible paper and plastic substrates (pretreated with PDAC) was evaluated by ink jet printing of silver NPs on (a) copier paper, (b) photo paper (Epson) and (c) a plastic (PET) electroluminescence (EL) device.

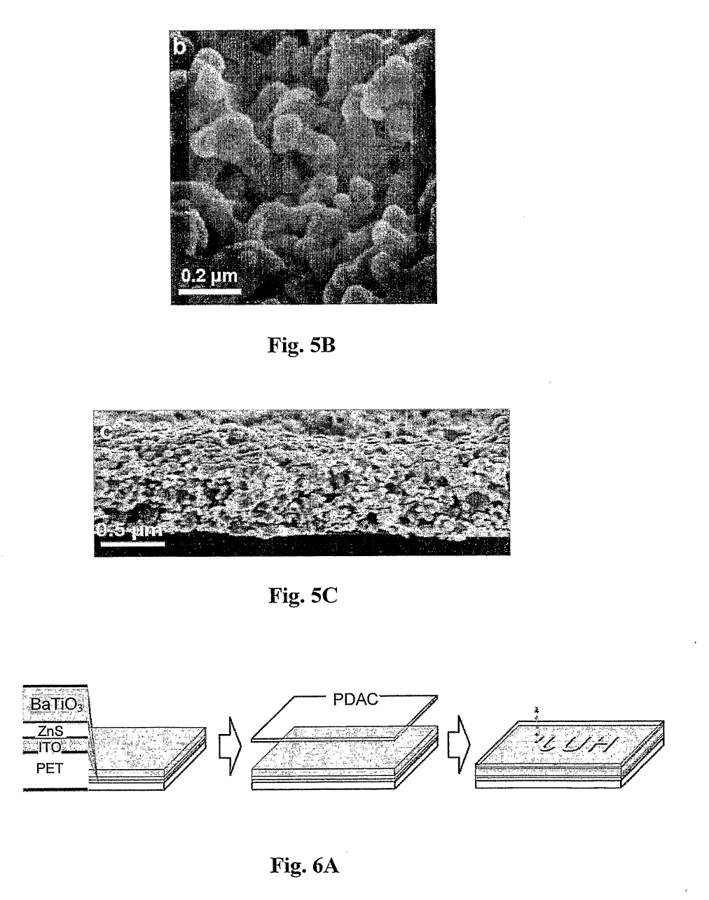

The copier paper and EL device top layer were pre-coated by PDAC (6 μm wet thickness of 0.1 wt % PDAC solution) prior to printing the silver pattern. In the case of the photo paper, since it already contains PDAC (according to energy dispersive spectrometry (EDS) data and according to an Epson patent [31]), no pretreatment was required. In general, it was found that the patterns printed on the two papers were sintered. FIG. 5 presents the pattern printed on the photo paper (FIG. 5A), and the SEM images of the sintered surface layer (FIG. 5B) and the cross-sectional area (FIG. 5C).

It was found that the patterns were conductive, having a sheet resistance and resistivity of 0.078 (±0.005) Ωsquare and 7.8 (±0.5) μΩcm, respectively, while printed on Epson photo paper and 0.68 (±0.07) Ωsquare and 68 (±0.7) μΩcm, respectively, while printed on copier paper (these resistivities did not change over a period of at least 6 months). It should be emphasized that such low resistivities, only 5 times higher than that of bulk silver (in the case of the photo paper), were reported until now only for metallic patterns heated at elevated temperatures [8,11] for extended periods while with the process of the invention, the low resistivity was achieved spontaneously at room temperature. The higher resistivity which was achieved on the copier paper was probably due to the surface roughness of the paper which affects the uniformity of the pattern and therefore reduces the number of percolation paths.

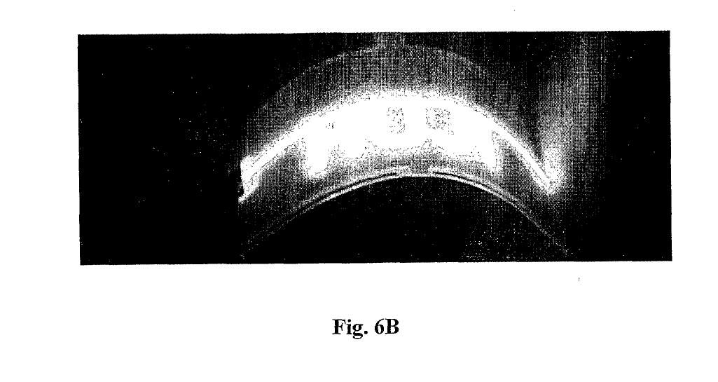

In order to evaluate the applicability of this sintering technique for plastic electronics, a flexible, transparent PET based electroluminescent device was constructed in two steps: 1) a four layers (PET:ITO:ZnS:BaTiO₃) electroluminescence device (MOBIChem Scientific Engineering) [32] was coated by PDAC on top of the BaTiO₃ layer (6 μm wet thickness of 0.1 wt % PDAC solution) and dried at room temperature, 2) a silver dispersion was ink-jet printed directly on top of the PDAC layer (schematically illustrated in FIGS. 6A-B). As demonstrated, a voltage (100 volts) applied between the ITO and the silver electrodes, resulted in a light emitting pattern (90 cd/sqm), corresponding to the printed silver pattern.

### Example 4

### Self-Sintering by NaCl

As mentioned above, instead of introducing the sintering agent to the NPs before or after the deposition of the NPs, it is possible to add a low concentration of the sintering agent to the NPs dispersion. Due to the evaporation of the liquid, in which the NPs are dispersed, the sintering agent concentration increases, leading to the sintering of the NPs.

Various NaCl concentrations were added to 15 nm silver NPs stabilized by PAA. The formulations contained 5 wt % propylene glycol, 0.05 wt % BYK 348 and 0 to 35 mM NaCl. Table 1 presents the sheet resistance of patterns obtained by depositing these formulations on glass by the draw-down technique and drying at 50° C.

TABLE 1
sheet resistance of patterns obtained by
employing varying concentrations of NaCl.

| | |
|---|---|
| No NaCl | Rsquare > 20 kΩ/square |
| 10 mM NaCl | Rsquare > 20 kΩ/square |
| 20 mM NaCl | Rsquare = 23 Ω/square |
| 35 mM NaCl | Rsquare = 0.77Ω/square |

1.-64. (canceled)

65. A process for sintering nanoparticles (NPs) on a substrate, comprising:
pre-coating the substrate with a film of the NPs and contacting the film with at least one sintering agent; or
pre-coating the substrate with a film comprising at least one sintering agent and contacting the film with the NPs,
wherein the process is carried out at a low temperature, to thereby permit sintering of the film on the substrate.

66. The process according to claim 65, wherein the NPs or at least one sintering agent are pre-formulated in an aqueous ink, the ink being applied onto the substrate and allowed to dry.

67. The process according to claim 65, wherein contacting is carried out by inkjet printing.

68. The process according to claim 65, wherein sintering is carried out at a temperature of from 5 to 150° C.

69. The process according to claim 65, wherein the sintering is spontaneous and does not require external application of energy.

70. The process according to claim 65, wherein the NPs is a plurality of one or more types of nanoparticles, each type being different in at least one of material, shape, size, chemical, and physical properties.

71. The process according to claim 70, wherein the plurality of NPs is selected from the group consisting of metallic nanoparticles, nanoparticles of one or more metal oxides, and semiconductor nanoparticles, silver, copper, gold, indium, tin, iron, cobalt, platinum, titanium, titanium oxide, silicon, silicon oxide, or any oxide or alloy thereof.

72. The process according to claim 66, wherein the NPs constitute from about 1 to 80% w/w of the total weight of the ink.

73. The process according to claim 65, wherein the at least one sintering agent is selected from the group consisting of a salt, a charged polymer, an acid, and a base.

74. The process according to claim 66, wherein the aqueous ink further comprises at least one dispersant.

75. The process according to claim 74, wherein the at least one dispersant is selected from the group consisting of polyelectrolites and polymeric materials capable of forming salts.

76. The process according to claim 74, wherein the at least one dispersant is at least one surfactant.

77. The process according to claim 66, wherein the aqueous ink comprises water in an amount of from 50 to 90% w/w of the ink.

78. The process according to claim 66, wherein the aqueous ink further comprises at least one additive selected to enhance performance, environmental effect, aesthetic effect, or enhance efficient application of the formulation onto a surface.

79. The process according to claim 65, wherein the pattern of sintered NPs is formed on a substrate by coating, dipping, printing, or inkjet printing.

80. The process according to claim 65, wherein the pattern covers the full surface of a substrate, the pattern is a continuous pattern on the substrate or a plurality of spaced apart patterns on the substrate, and wherein the thickness of the pattern is optionally between 0.05 to 50 micrometers.

81. The process according to claim 65, wherein the substrate is selected from the group consisting of glass, polymeric films, plain paper, porous paper, non-porous paper, coated paper, flexible paper, copier paper, photo paper, glossy photopaper, semi-glossy photopaper, heavy weight matte paper, billboard paper, vinyl paper, high gloss polymeric films, transparent conductive materials, plastic (poly(ethylene terephthalate), PET, polyacrylates (PA), polyethilene naphtalate (PEN), polyethersulphone (PES), polyethylene (PE), polyimide (PI), polypropylene (PP), and polycarbonate (PC).

82. The process according to claim 65, wherein the sintered film of NPs is electrically conductive.

83. An article having at least one sintered surface prepared according to a process of claim 65.

84. The article according to claim 83, wherein th sintered surface is conductive.
